(19) United States
(12) Patent Application Publication
(10) Pub. No.: US 2011/0143769 A1
(43) Pub. Date: Jun. 16, 2011

(54) DUAL DISPLAY MOBILE COMMUNICATION DEVICE

(75) Inventors: Gregory Glenn Jones, Seattle, WA (US); Lisa M. Hanson, Issaquah, WA (US); Thomas Kleist, Redbourn (GB); Jesper Brehmer, London (GB)

(73) Assignee: Microsoft Corporation, Redmond, WA (US)

(21) Appl. No.: 12/639,924

(22) Filed: Dec. 16, 2009

(51) Int. Cl. H04W 24/00; H04B 1/38; H04W 4/00

(52) U.S. Cl. 455/456.1; 455/566; 455/557; 455/422.1

(57) ABSTRACT

A dual display mobile device comprises a first device with a first display and a second device with a second display. The mobile device can operate as a mobile cell phone. In a closed configuration of the mobile device, the first display is exposed and the second display is hidden. In an open configuration, both displays are exposed. In a detached configuration, the second device is separated from the first device and the second device can operate as a mobile phone handset. The separated first and second device can communicate wirelessly. The detachable second device allows a user to utilize the full capabilities of the mobile phone without having to remove the second device away from the user's ear, thus preserving the privacy of a phone call. The first and second displays can interact with each other or operate independently in the open, closed or detached configurations.

### FIELD

The present disclosure relates to dual display mobile devices, and, more particularly, to dual display mobile devices that can operate as a mobile cellular phone.

### BACKGROUND

Modern mobile phones have evolved over recent years to the point where they now possess a broad range of capabilities. They are not only capable of placing and receiving mobile phone calls, multimedia messaging (MMS), and sending and receiving email, they can also access the Internet, are GPS-enabled, possess considerable processing power and large amounts of memory, and are equipped with high-resolution color liquid crystal displays capable of detecting touch input. As such, today's mobile phones are general purpose computing and telecommunication devices capable of running a multitude of applications. For example, modern mobile phones can run web browser, navigation system, media player and gaming applications.

Along with these enhanced capabilities has come a demand for larger displays to provide a richer user experience. Mobile phone displays have increased in size to the point where they can now consume almost the entire viewing surface of a phone. To increase the size of displays any further would require an increase in the size of the phones themselves. This is not desirable, as users want their mobile phone to fit comfortably in their hand or in a shirt or pants pocket.

Another limitation of modern mobile phones is that a user typically cannot use a phone's full capabilities while on a phone call. This is because, for example, a user cannot see a phone's display when the phone is held up to his or her ear. Separate earpieces, earbuds or wireless headsets may allow a user to view a mobile phone display and utilize “non-phone” functions while on a call, but these peripheral components have their disadvantages. A user needs to keep track of these additional components and wireless headsets must be charged prior to use. Further, some users simply do not like to wear headsets. As another option to view a display while making a call, a user can utilize a mobile phone's speakerphone mode. However, this mode often involves notably increasing the speaker volume. Thus, the privacy of the call is lost if anyone else is within hearing distance. Further, as the mobile phone speaker can be a more than a foot or two away from the user's ear, it may be more difficult to hear the speaker over any ambient noise.

Accordingly, it is desirable to provide a mobile communications device that is sized for convenience and yet allows the user to utilize the full functionality of the device.

### SUMMARY

A handheld mobile communication device is disclosed that allows a user to utilize the full capabilities of the device while conducting a private phone call.

In one embodiment, the mobile phone includes two displays on two separate devices. The separate devices can be attached and the two displays can be used as an integrated display or the devices can be detached and the devices can communicate wirelessly with each other.

In another embodiment, the mobile phone can include an open, expanded position and a closed, condensed position. In the open position, both displays are visible and can be flush so that the user feels like there is a single integrated display. For example, one application (e.g., a map application) can extend between both displays. In a closed position, the second display can tuck beneath the first device so that the mobile phone is reduced in size and can be easily carried.

In yet another embodiment, one or both of the devices can include an accelerometer for receiving user input. The user input from the accelerometer can be used for gaming applications. For example, the second device can be used as a gaming control that wirelessly communicates motion information to the first device.

In a further embodiment, a controller in the first and/or second devices can monitor for detachment between the first and second devices and automatically switch between a first mode of communication wherein a physical electrical connector is used and a second mode of communication wherein wireless communication is used.

In yet another embodiment, both the first and second devices can communicate wirelessly there between while simultaneously communicating with a wireless communication network. Thus, for example, the first device can be used as a base unit for communicating with the wireless communication network while the second device acts as a handset in constant wireless communication with the first device. Additionally, both devices can be used as handsets to allow two people at one end of a phone call to participate in a private conversation.

These and other aspects, features and advantages of the technology will become apparent from the following description and referenced drawings.

### BRIEF DESCRIPTION OF THE DRAWINGS

FIG. 1(a) shows top and side profiles of an exemplary dual display mobile device in a closed configuration.

FIG. 1(b) shows top and side profiles of an exemplary dual display mobile device in an open configuration.

FIG. 2(a) shows a perspective view of an exemplary dual display mobile device in a closed, attached configuration.

FIG. 2(b) shows a perspective view of an exemplary dual display mobile device in an open, attached configuration.

FIG. 2(c) shows a perspective view of an exemplary dual display mobile device in an open, detached configuration.

FIG. 2(d) shows a perspective view of an exemplary dual display mobile device in a closed, detached configuration.

FIG. 3(a) shows a side profile of an exemplary dual display mobile device in an open, attached configuration with a second device in a lowered position.

FIG. 3(b) shows a side profile of an exemplary dual display mobile device in an open, attached configuration with a second device in a raised position.

FIG. 4(a) shows top and side profiles of an exemplary dual display mobile device in a closed configuration.

FIG. 4(b) shows top and side profiles of an exemplary dual display mobile device in an intermediate position between open and closed configurations.

FIG. 4(c) shows top and side profiles of an exemplary dual display mobile device having planar front and back surfaces in a closed configuration.

FIG. 5(a) shows perspective and side profile views of an exemplary dual display mobile device in a closed, attached configuration.

FIG. 5(b) shows perspective and side profile views of an exemplary dual display mobile device in an open, attached configuration.

FIG. 5(c) shows perspective and side profile views of an exemplary dual display mobile device in a detached configuration.

FIG. 6 shows a top view of an exemplary dual display mobile device running a map application displayed on first and second displays operating as a shared display.

FIG. 7 shows a top view of an exemplary dual display mobile device with the first display showing the output of a map application and the second display showing application icons.

FIG. 8 is a flowchart of an exemplary dual display mobile device showing hardware components.

FIG. 9 shows a user operating an exemplary dual display mobile device as a mobile phone with the second device being used as a handset.

FIG. 10 is a flowchart of a first embodiment of a method of operating a dual display mobile device as a mobile phone.

FIG. 11 is a flowchart of additional operations that can be performed as part of the flowchart shown in FIG. 10 for wirelessly communicating with a mobile communication network during a phone call.

FIG. 12 is a flowchart of additional operations that can be performed as part of the flowchart shown in FIG. 10 for displaying the location of the mobile phone and another party to the call on a map.

FIG. 13 shows a second device of an exemplary dual display mobile device operating as a remote game controller for a first device outputting video to a television.

FIG. 14 is a flowchart of a second embodiment of a method of operating a dual display mobile device as a mobile phone.

FIG. 15 shows an exemplary dual display mobile device comprising a first device having a hinged edge in a detached configuration.

### DETAILED DESCRIPTION

As used in this application and in the claims, the singular forms “a,” “an,” and “the” include the plural forms unless the context clearly dictates otherwise. Additionally, the term “includes” means “comprises.”

The described systems, apparatus and methods described herein should not be construed as limiting in any way. Instead, the present disclosure is directed toward all novel and non-obvious features and aspects of the various disclosed embodiments, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language set forth below. For example, operations described sequentially can in some cases be rearranged or performed concurrently. Moreover, for the sake of simplicity, the attached figures cannot show the various ways in which the disclosed systems, methods and apparatus can be used in conjunction with other systems, methods and apparatus. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

Theories of operation, scientific principles or other theoretical descriptions presented herein in reference to the apparatus or methods of this disclosure have been provided for the purposes of better understanding and are not intended to be limiting in scope. The apparatus and methods in the appended claims are not limited to those apparatus and methods that function in the manner described by such theories of operation.

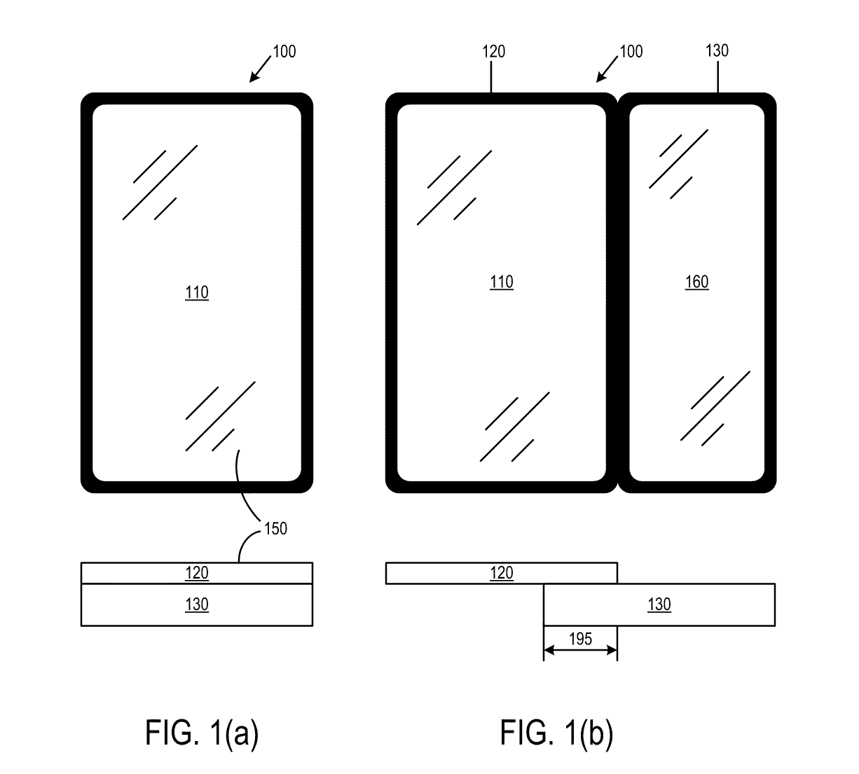

Turning now to the drawings, FIGS. 1(a) and 1(b) show an exemplary dual display mobile communication device (mobile device) 100 comprising a first portion 120 and a second portion 130. The first portion 120 comprises a first display 110 and the second portion 130 comprises a second display 160. The mobile device 100 is capable of mobile telecommunications (telephony, multi-media messaging (MMS), data transmission, etc.) over a mobile communication network (cellular, satellite, etc.). The mobile device 100 can run standard productivity software such as email, calendar and address book programs, as well as being able to operate as a web browser, gaming system, media player, photo gallery and/or navigation system, to provide several examples. The mobile device 100 can be configured to download and execute a wide variety of additional applications. The mobile device 100 can be GPS-enabled, allowing applications to take advantage of the mobile device's location.

FIG. 1(a) shows the dual display mobile device 100 in a closed configuration or position in which the first portion 120 can be arranged in front of, or on top of, the second portion 130. In the closed configuration, the mobile device 100 can fit comfortably in a person's hand or in a shirt, pants or coat pocket. In the closed configuration, the first display 110 can be exposed (i.e., viewable to a user) and the second display 160 can be hidden from view. In this example, the first display 110 occupies a large portion of the front surface 150 of the mobile device 100. In other embodiments, the first display 110 can comprise a smaller portion of the first surface 150 to allow room for various input devices such as a track ball, physical keyboard or one or more buttons. These buttons can be programmed to perform a variety of tasks such as returning to a home page or launching a specific application. The displays 110 and 160 can each be a touchscreen capable of detecting input from various objects (finger, stylus, etc.) in contact and/or in proximity with the display.

FIG. 1(b) shows the mobile device 100 in an open, expanded configuration. The second portion 130 has been moved laterally relative to the first portion 120 to expose the secondary display 160. The mobile device 100 in the open configuration has a wider profile than in the closed configuration, but can still be held in a person's hand. The first and second portions 120 and 130 are connected physically and electronically in the open and closed configurations. The electrical connection between the first portion 120 and the second portion 130 can be made via a flex cable or other well-known electrical connection mechanism.

In this example, the first portion 120 is shown as being thinner than the second portion 130. In such a configuration, most of the electrical components comprising the mobile device 100 reside in the second portion 130. In other embodiments, the first portion 120 and the second portion 130 can have varying relative thicknesses. That is, the first portion 120 and the second portion 130 can have substantially the same thickness, or the first portion 120 can be thicker than the second portion 130. When the mobile device 100 is in the open configuration, the first portion 120 and the second portion 130 remain overlapped by a distance 195. Accordingly, the width of the second display 160 is generally narrower than that of the first display 110. The mobile device 100 can contain additional features such as an on/off switch, volume controls, a speaker, a microphone and input/output ports for sending and/or receiving data and/or for recharging the power supply of the mobile device 100.

In some embodiments, the mobile device 100 can be configured such that the second portion 130 can be removed and replaced with a different component. For example, a user about to embark on a long airplane flight can replace the second portion 130 with an extra battery to extend the operating time of the mobile device 100. The second portion 130 can be replaced with various other components such as a game controller, battery or physical keyboard. These additional components can be arranged behind the first portion when the mobile device is in a closed configuration. To re-close the mobile device 100, the user can push both portions 120 and 130 in opposite directions and towards one another to make portion 130 slide beneath portion 120.

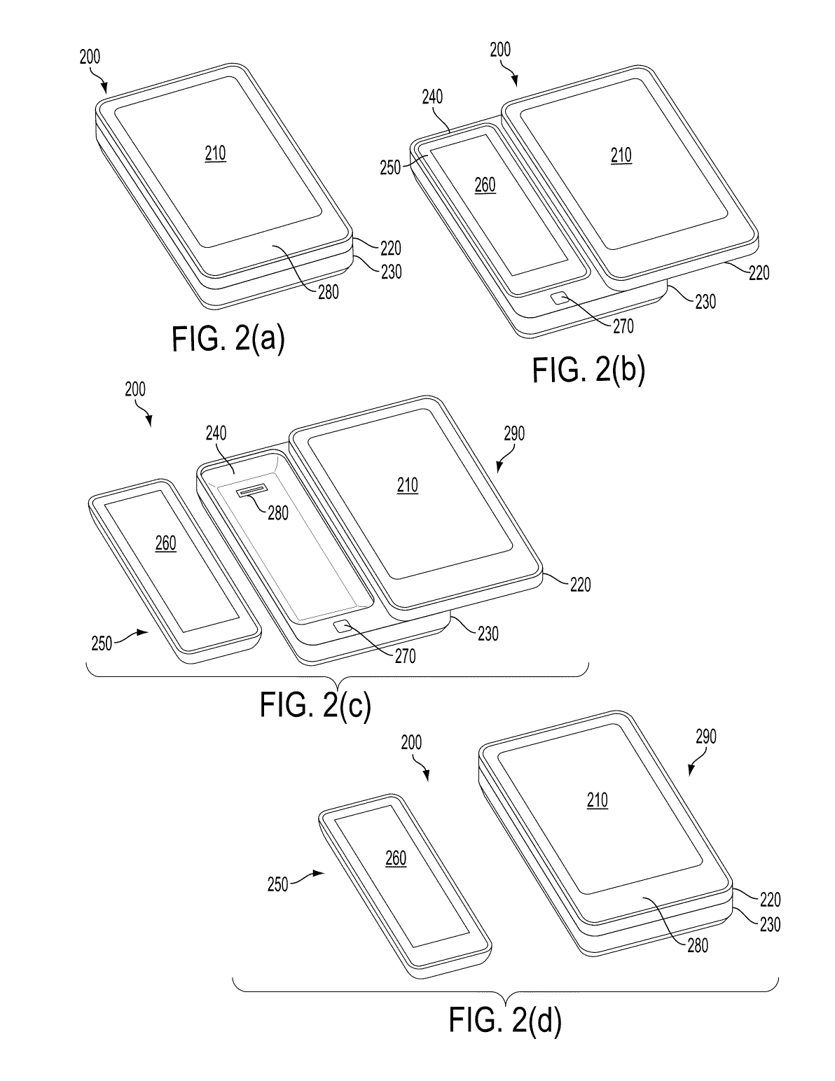

FIGS. 2(a)-2(d) show an exemplary dual display mobile device 200 comprising a first device 290 and a removable second device 250. The first device 290 comprises a first display 210, a first portion 220 and a second portion 230 (excluding the second device 250). The second device 250 comprises a second display 260 and can be stored in the second portion 230. The first portion 220 and the second portion 230 can move laterally relative to each other to transition between the open and closed configurations of the mobile device 200. FIG. 2(a) shows the mobile device 200 in a closed, attached configuration in which the second device 250 can be stored within a well or pocket 240 in the second portion 230. The first display 210 can be exposed and the second display 260 can be hidden from view.

FIG. 2(b) shows the mobile device 200 in an open, attached configuration in which the first portion 220 has been moved laterally relative to the second portion 230 to expose the second device 250. In this example, the second device 250 can be stored within a well 240 of the second portion 230. The second device 250 can be releasably secured within the well 240 by way of, for example, a mechanical catch (not shown). The second device 250 can be released from the first device 290 by, for example, pressing a button 270 or other release mechanism. Regardless of the mechanism used to secure the second device 250 to the first device 290, the mechanism should prevent the second device 250 from being unintentionally separated from the second portion 230. In other embodiments, the second device 250 can be secured within the well 240 by magnets, latches, clasps or other known techniques for releasably attaching one component to another.

FIG. 2(c) shows the dual display mobile device 200 in an open, detached configuration in which the second device 250 has been detached from the first device 290. In this example, detaching the second device 250 from the first device 290 reveals an electrical connector 280 in the base of the well 240. The electrical connector 280 mates with a complementary electrical connector in the second device 250 (not shown) to allow for electronic communication between the first and second devices 290 and 250. The electrical connector 280 can be, for example, a USB connector or any other type of electrical connector. The electrical connector can also allow the first and second connector to be recharged using a single power supply. The electrical connector 280 can be located at any position within the well 240. Components other than the second device 250 can be stored in the well 240. For example, the well 240 can store an extra battery, physical keyboard or game controller.

FIG. 2(d) shows the mobile device 200 in a closed, detached configuration. The first portion 220 can be arranged in front of the second portion 230, similar to the closed attached configuration shown in FIG. 2(a). As discussed in detail below, the first device 290 and the second device 250 can communicate wirelessly to operate in a coordinated fashion, or, the two devices can operate independently of each other.

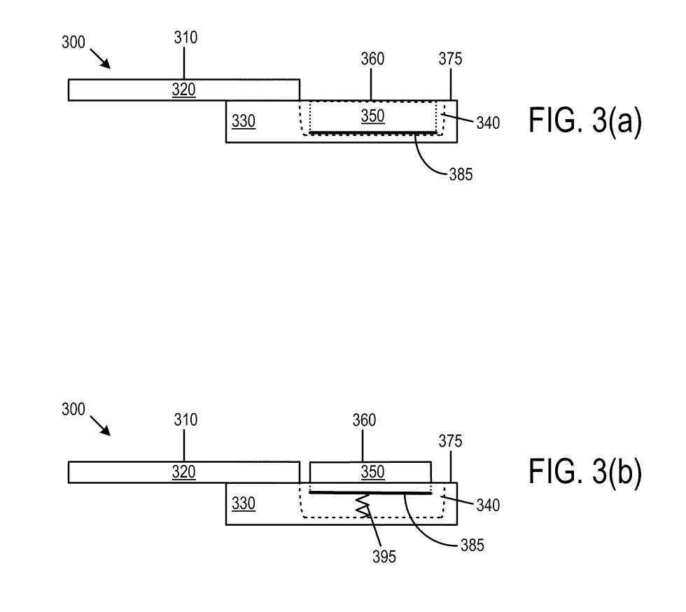

FIGS. 3(a)-3(b) shows an exemplary dual display mobile device 300 comprising a second device 350 that can be raised to make a second display 360 flush with a first display 310. The mobile device 300 comprises a first portion 320 and a second portion 330. A second display 360 that can be positioned flush with the first display 310 can make a user feel like the two displays are a single integrated display. The first portion 320 comprises the first display 310 and the second portion 330 comprises a well 340 capable of storing the second device 350. The second device 350 comprises the second display 360.

FIG. 3(a) shows the second device 350 in a lowered position in which the surface of the second display 360 is flush with a top surface 375 of the second portion 330. FIG. 3(b) shows the second device 350 in a raised position in which the second device 350 is raised relative to the second portion 330 and the surface of the second display 360 is flush with the surface of the first display 310. The second device 350 can move between the lowered and raised positions by, for example, the use of a spring-loaded panel 385 connected to the second portion 330 by a spring 395. When the second device 350 is in the lowered position, the spring 395 can be compressed and the spring panel 385 can be held in place by, for example, a mechanical latch or other mechanism. The latch can be released, allowing the spring 395 to extend and lift the second device 350 into the raised position. Repeatedly pressing on the second device 350 can alternately engage and disengage the release mechanism, allowing the second device to move between the lowered and raised positions. Other mechanisms can be used to make the two displays flush. For example, a bottom of the second portion 330 can have a cut out that can be moved up or down through upward or downward pressure exerted on the cut out by a user.

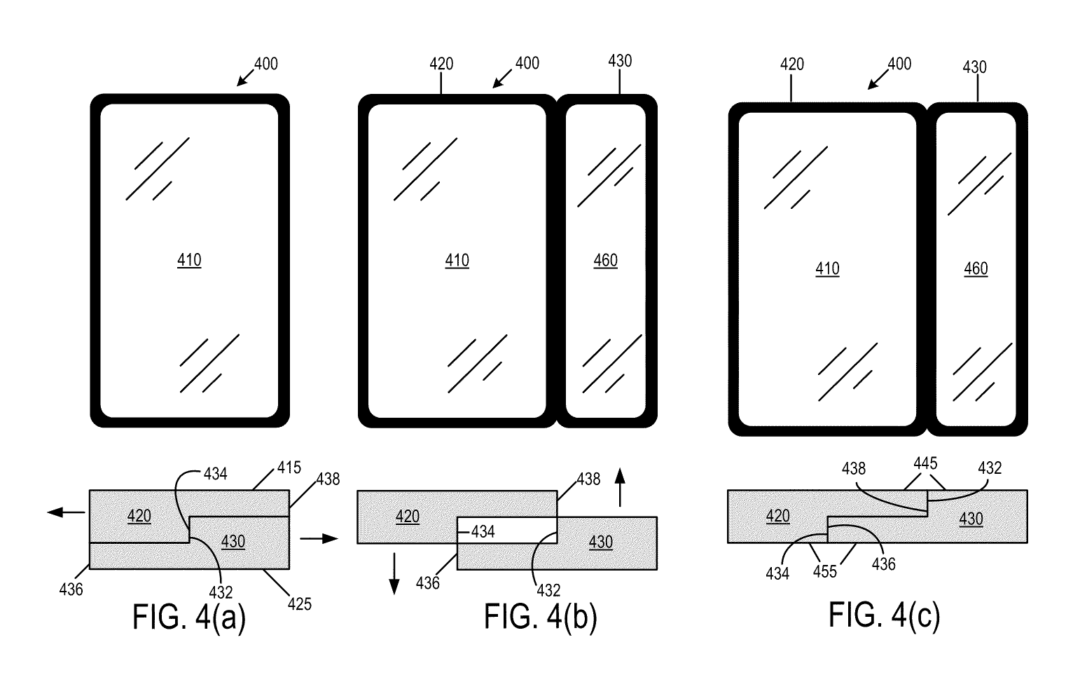

FIGS. 4(a)-4(c) show an exemplary dual display mobile device 400 having planar front and back surfaces in both open and closed configurations. The mobile device 400 comprises a first portion 420 and a second portion 430. The first portion 420 comprises a first display 410 and the second portion 430 comprises a second display 460. FIG. 4(a) shows the mobile device 400 in a closed configuration with the second portion hidden beneath the first portion. A front surface 415 and a back surface 425 of the mobile device 400 are substantially flat, or planar. For example, the first and second portions 420 and 430 have similar L-shaped cross-sections and are physically and electronically connected in both the open and closed configurations.

The first and second portions 420 and 430 can move relative to each other along at least two dimensions, as indicated by the arrows in FIGS. 4(a) and 4(b). For example, the first and second portions 420 and 430 can slide horizontally relative to each other, as shown by the arrows in FIG. 4(a), to transform the mobile device 400 from the closed configuration shown in FIG. 4(a) to the intermediate position shown in FIG. 4(b). Thus, sliding the second portion 430 from out behind the first portion 420 exposes the second display 460. The two portions can also slide vertically relative to each other, as indicated by the arrows in FIG. 4(b), to transition the mobile device 400 from the intermediate position to the open configuration shown in FIG. 4(c). Thus, transforming the mobile device 400 from a closed configuration to an open configuration involves either sliding the first portion 420 “over and down” relative to the second portion 430, or sliding the second portion 430 “over and up” relative to the first portion 420.

The complementary L-shaped cross-sections of the first and section portions 420 and 430 allow for flat or planar front and back surfaces 445 and 455 when the mobile device 400 is in an open configuration, and for planar front and back surfaces 415 and 425 when the device is in a closed configuration. The L-shaped cross-sections can provide for front and back surfaces that do not have any gaps between the first and second portions 420 and 430 in the open configuration. That is, edges 438 and 434 of the first portion 420 are immediately adjacent to edges 432 and 436 of the second portion 430, respectively, in the open configuration.

A dual display mobile device having planar front and back surfaces in both open and closed configurations is more desirable to use. For example, flush first and second displays are easier to view than first and second displays that are vertically displaced from each other. Further, a user can more easily apply touch gestures, such as (“drag and drop,” “pinch to zoom,” etc.) across flush displays. Furthermore, a mobile device with a planar back surface is less prone to wobbling when a user is providing touch input to the device, which allows for quicker and more reliable input. Moreover, a planar back surface allows the first and second displays to be presented parallel to the surface of the object upon which the mobile device is resting. That is, the device will not tip away from or toward the user when the device is placed on a flat surface. In other embodiments, the cross-sections of the first and second portions can possess shapes other than the L-shape shown in FIGS. 4(a)-4(c).

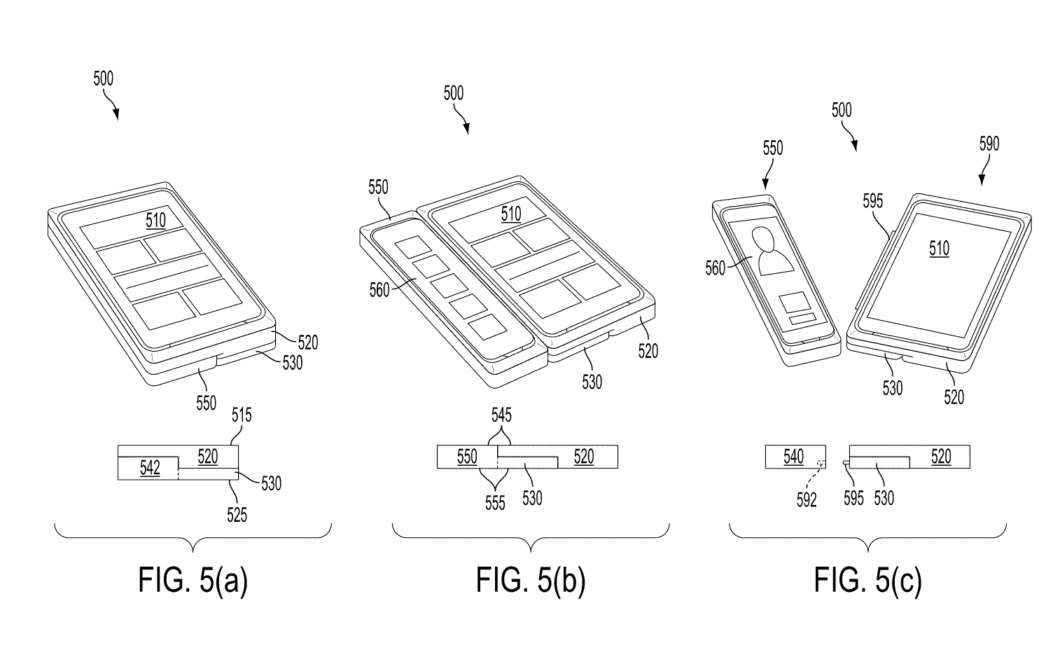

FIGS. 5(a)-5(c) show an exemplary dual display mobile device 500 comprising a first device 590 and a second device 550. The first device 590 comprises a first display 510, a first portion 520 and a second portion 530. The mobile device 500 has substantially planar front and back surfaces 515 and 525, respectively, in a closed configuration and planar front and back surfaces 545 and 555, respectively, in an open configuration. The second portion 530 can move relative to the first portion 520 in at least two dimensions to transition between open and closed configurations. The second device 550 can be attached to the second portion 530 in the open and closed configurations, and can move relative to the first portion 520 together with the second portion 530.

FIG. 5(a) shows the mobile device 500 in a closed, attached configuration with the second device 550 arranged behind or beneath at least part of the first portion 520. In this example, the first display 510 is exposed in the closed configuration. The second display 560 is hidden from view. FIG. 5(b) shows the mobile device 500 in an open, attached configuration in which both the first display 510 and the second display 560 are exposed or visible. FIG. 5(c) shows the mobile device 500 in a detached configuration in which the second device 550 is detached from the first device 590. As described further below, in the detached configuration, the first and second devices communicate wirelessly there between.

In this example, the second device 550 is attached to the second portion 530 by a connector. As shown in FIG. 5(c), the connector can comprise a male connector portion 595 that is part of the second portion 530 and a female connector portion 592 that is part of the second device 550. The male connector portion 595 can comprise pins that fit into sockets of the female connector portion 592. Alternatively, the male connector portion 595 could be integrated into the second device 550 and the female connector portion 592 could be integrated into the first device 590. In addition to providing a physical connection, the connector can provide an electrical connection between the first and second devices 590 and 550 for communication electrically there between. The connector can be any known mechanism for providing a physical and electrical connection between devices. In some embodiments, the first and second devices can be separated by pulling the devices apart. In other embodiments, the devices can be separated by sliding the devices relative to each other, and then pulling them apart. In yet other embodiments, the devices can be physically connected by the use of magnets or any releasable mechanical couplers.

The second device 550 can be replaced by various other components to provide additional functionality or features. For example, a physical keyboard, game controller, extra battery or other component can be attached to the first device 590 instead of the second device 550. These components can have the same profile as the second device 550 so that they can be stowed behind the first device 590 when the mobile device 500 is in a closed configuration. In any of the examples described herein, the second display can be arranged either to the left or to the right of the first display when the mobile device is in an open configuration.

In other embodiments, a component having a display larger than the display 560 can be attached to the first device 590 to allow for an even larger combined display (first display plus second display) than that shown in FIG. 5(b). In other embodiments, multiple displays can be attached to the first device 590, for example, in a daisy-chain fashion, to create large combined displays. In some embodiments, first or second devices of other mobile devices as described herein can be attached to the first device 590.

In any of the examples described herein, the second display of a mobile device, when exposed, can operate as an extension of the first display. That is, the first and second displays can act together to create an effective larger, single integrated display, or a shared display. By being integrated, items from the first display can be moved to the second display via drag-and-drop operations. Additionally, applications and images can span both displays to provide the experience of a single unitary display. Or, clicking an application icon on one display can open the application on the other display. The increased display area provides a richer user experience.

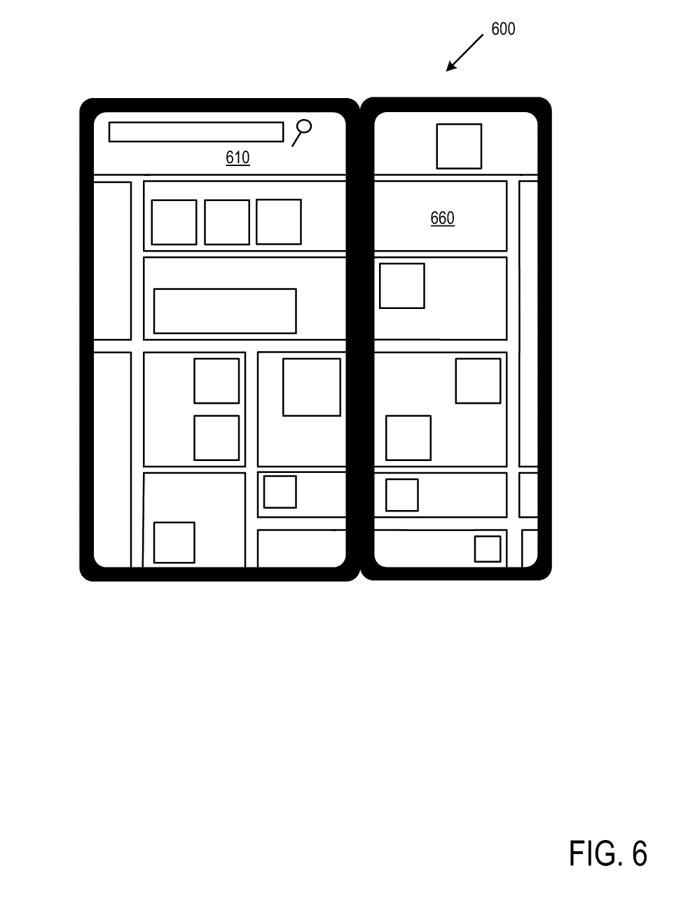

FIG. 6 shows an exemplary dual display mobile device 600 displaying the output of a map or navigation application across a first display 610 and a second display 660. In any of the examples described herein, one or both of the first and second displays can be updated in response to input received at one or both of the displays. For example, with reference to FIG. 6, in response to the detection of a multi-touch “pinch” gesture (two fingers touching the display moving toward each other) on the first display 610, the mobile device 600 can update both the first and second displays 610 and 660 to zoom out from the selected map area. The mobile device 600 can zoom in, zoom out, rotate the map or perform other operations in response to multi-finger gestures detected on the first display 610, the second display 660 or both displays (e.g., one finger touching the first display and a second finger touching the second display). The mobile device 600 can perform operations in response to multi-finger gestures in an application programmed to respond to such gestures. Further, the mobile device 600 can be configured to perform operations in response to single finger gestures that begin on one display and end on the other display. Furthermore, the mobile device 600 can perform operations associated with “flick” gestures, quick, linear movements by a finger, stylus, etc., received at one or both of the displays.

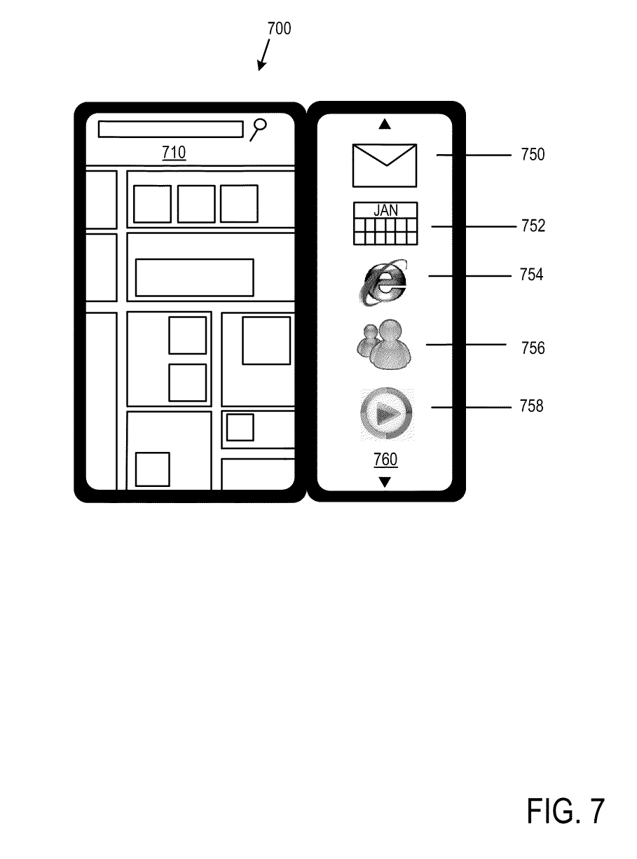

The first and second displays can display related or associated information in other manners. FIG. 7 shows an exemplary dual display mobile device 700 in an open configuration with a first display 710 and a second display 760. In this example, the output of an application running on the mobile device 700 (in this case, a map or navigation application) is shown on the first display 710, and a list of icons 750, 752, 754, 756 and 758 associated with various applications (email, calendar, web browser, text messenger, media player, etc.) is shown on the second display 760. The mobile device 700 can update one or both of the displays based on input received from the other or both displays. For example, in response to a user touching the portion of the second display 760 associated with the email icon 750, the mobile device 700 can launch an email application and direct its output to the first display 710. This allows the icons to remain visible despite the application opening. In another example, the first display 710 can display the output of an email program or other application that requires text input, and the second display 760 can operate as a virtual keyboard. In such a configuration, as the user taps the second display 760 to compose a message, the associated text can appear at the first display 710.

The first and second displays 710 and 760 can display related information in additional manners. For example, the secondary display 760 can display information that is supplemental or complementary to that displayed on the first display 710. For instance, the second display 760 can display directions for a map route shown on the first display 710, or display a reading pane for an email application displayed on the first display 710. In another example, the device 700 can be configured to allow a user to interact with the second device 760 to browse a media gallery (photo, audio, video, etc.) and select media files for inclusion into an email message, text media or other communication being composed at the first display 710. A user can select the media files for inclusion into the communication, for example, by tapping an icon displayed on the second display 760 or by dragging an icon from the second display 760 to the first display 710. The second display 760 can also notify a user of an incoming phone call, text or calendar appointment. In any event, the first and second displays can display related content (e.g., text, images, etc.)

In another example, with reference to FIG. 5(b), a first display 510 can display a home or main page that shows, for example, the user's current location, local time, upcoming calendar appointments, number of unread email and MMS messages, and number of voice messages. The second display 560 could display a list of icons 555 associated with various applications. In any of the examples described herein, the first and second displays can operate independently when attached. For example, in any open, attached configuration, the first display and second displays can each display the output of a separate application.

In any of the examples described herein, the first and second devices can interact as long as they are within wireless communication range of each other. For example, the display of a detached second device can display information that is supplemental or complementary to, or that otherwise is associated with or corresponds to, the information shown on the first display. For instance, the first and second displays can display the output of a single application, the second display can present information related or supplemental to an application displayed in the first display, the first display can display information related to an application running on the second device, or the second display can display a list of icons of applications that can. Additionally, the first and second displays can display identical information for presenting content to a person holding the other display. For example, an identical series of photograph images can be displayed on both displays and advancement on the first display due to user input can result in the automatic updating of the second display.

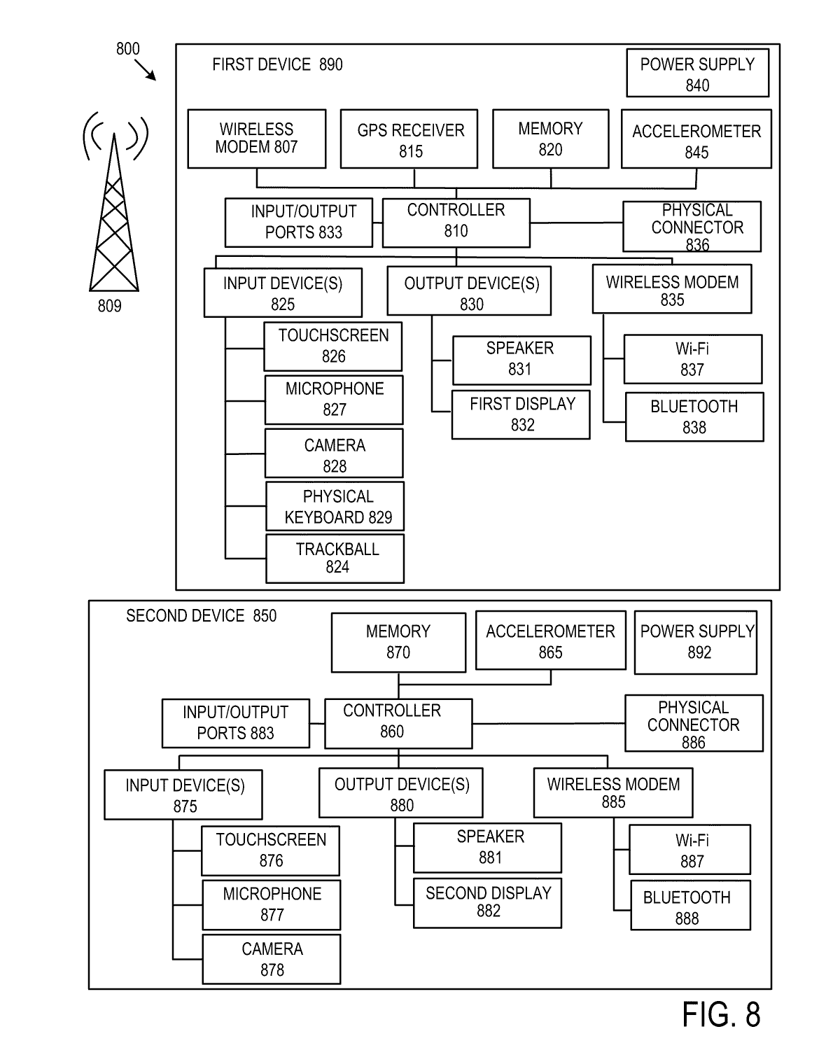

FIG. 8 is a flowchart of a dual display mobile device 800 comprising a first device 890 and a detachable second device 850. The first device 890 comprises a controller or processing unit 810, memory 820, one or more input devices 825, one or more output devices 830, at least one input/output port 833, a power supply 840, and a physical connector 836. The first device 890 also comprises a wireless modem 807 (e.g., a cellular modem) for communicating with one or more mobile communication networks 809 and a wireless modem 835 for communicating with the second device 850. The mobile communication network 809 can be a cellular, satellite or other type of mobile communication network. The first device 890 can further comprise a Global Positioning System (GPS) receiver 815 and/or an accelerometer 845. Each component in the first device 890 can communicate with any other component, although only connections between the controller 810 and other components are shown. The power supply 840 typically comprises a rechargeable battery. The one or more input devices 825 can include, for example, a touchscreen 826, microphone 827, camera 828, physical keyboard 829 and/or trackball 824. The one or more output devices 830 can include, for example, a speaker 831 and first display 832. A first device 800 comprising a microphone 827 and a speaker 831 can have the microphone 827 and the speaker 831 arranged such that the first device 800 can be used as a mobile phone headset. That is, when such a first device 800 is positioned near a user's head, the microphone 827 is near the user's mouth and the speaker 831 is near the user's ear. The first device 890 can include additional input and/or output devices. The physical connector 836 physically connects the first device 890 to the second device 850.

The second device 850 comprises a controller or processing unit 860, memory 870, one or more input devices 875, one or more output devices 880, at least one input/output port 883, a power supply 892, a physical connector 886, and a wireless modem 885 for communicating with the first device 890. The second device 850 can further comprise an accelerometer 865. Each component in the second device can communicate with any other component in the second device, although only connections between the controller 860 and other components are shown in FIG. 8. The one or more input devices 875 can include, for example, a touchscreen 876, microphone 877 and camera 878. The second device 850 can include additional input devices such as a physical keyboard or trackball. The one or more output devices 880 can include, for example, a speaker 881 and a second display 882. A second device 850 comprising a microphone 877 and a speaker 881 can be configured such that the second device 850 can be used as a mobile phone headset. That is, when such a second device 850 is positioned near a user's head, the microphone 877 is near the user's mouth and the speaker 881 is near the user's ear. The physical connector 886 can be configured to mate with the physical connector 836 of the first device to physically and electronically connect the two devices.

The power supply 892 typically comprises a rechargeable battery. The rechargeable battery can be charged when the second device 850 is attached to the first device 890 so that a single power source charges both batteries. In some embodiments, the first device 890 can charge the power supply 892 when the power supply 840 is being recharged (for example, when the first device 890 is docked at a charging station). In other embodiments, either device can be powered by its own power supply, the power supply of the other device, or a combination of both. In still other embodiments, the power supply of either device can be recharged by the power supply of the other device. The conditions under which one device is powered or recharged by the other device can be determined, for example, by default settings established during manufacture, or through user-configurable settings. The first and second devices can each be powered by an external power supply.

The wireless modems 835 and 885 of the first and second devices 890 and 850, allow for wireless communication between the devices. The wireless modems 835 and 885 can each comprise a Bluetooth modem 838, a Wi-Fi modem 837 and/or any other hardware capable of providing a wireless communication link. The wireless modems 835 and 885 can each also communicate with other wireless-enabled devices within communication range of the first and second devices 890 and 850. For example, the wireless modems 835 and 885 can provide a communication link from the first or second device 890 or 850 to a nearby personal computer, printer, media player, mobile phone or other devices capable of wireless communication. In some embodiments, the first device 890 can act as a relay or base station to enable communication between a second device and another wireless device. The wireless modems 835 and 885 can comprise both a Wi-Fi modem 837 and a Bluetooth modem 838. In this case, the first or second device can be configured to switch between the two modems to take advantage of the greater communication range typically provided by Wi-Fi modems and the reduced power consumption typically provided by Bluetooth modems.

The first and second devices 890 and 850 can also comprise accelerometers 845 and 865, respectively. The first and second devices 890 and 850 can be configured to use an accelerometer, for example, to detect the orientation of the device and adjust the output sent to the first and second displays accordingly. The accelerometers 845 and 865 enable additional features. For example, the first and second devices can each be configured to perform operations in response to a user gesturing with either device. For example, a device can perform various operations in response to a user waving or shaking the device. One example of using the device in response to movement is a gaming application, as discussed further below.

The at least one input/output ports 833 and 883 of the first and second devices can each include at least one output port. The output port can output audio and/or video data to, for example, a set of speakers (headphones), a stereo receiver, a television or other media player. The audio or video data can be output in analog and/or digital format. The input/output ports 833 and 883 can each also include a port for communicating data with any external device such as a personal computer, printer, etc.

The memories 820 and 870 of the first and second devices can be volatile memory (e.g., registers, cache, RAM), non-volatile memory (e.g., ROM, FPGA, PAL, CPLD, EEPRAM, flash memory), or some combination of both. The memories 820 and 870 can store software implementing any of the functionalities described herein. Typically, operating system software (not shown) provides an operating environment for other software executing in either the first or the second devices 890 and 850, and coordinates activities of the components of the devices.

In other embodiments, the first and second device 890 and 850 can have more or fewer components than those depicted in FIG. 8. For example, the wireless modem 807 responsible for communicating with the one or more mobile communication networks 809 can be located in the second device 850. Alternatively, both the first and second devices can have a wireless modem capable of communicating with the one or more mobile communication networks 809. The first and second devices could also each have more or fewer input or output devices. For example, the second device 850 could have a camera. Further, the second device 850 could comprise a GPS receiver.

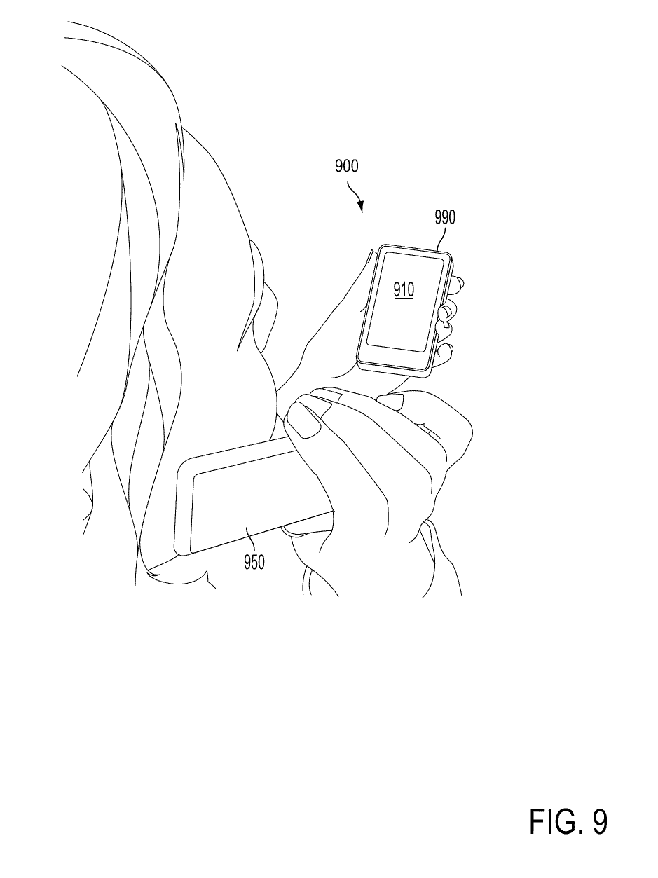

FIG. 9 shows a dual display mobile device 900 comprising a first device 990 and a second device 950 being used as a mobile phone. Any of the dual display mobile devices with a detachable second device as described herein provides the user with the ability to conduct a private phone conversation while simultaneously utilizing capabilities of the mobile device unrelated to conducting the mobile phone call (“non-call capabilities”). In FIG. 9, a user has detached the second device 950 from the first device 990 and is holding the second device 950 up to his or her ear with one hand to use the second device 950 as a mobile phone handset to conduct a private call. The first device 990 wirelessly communicates signals associated with a phone call to both a wireless communications network (e.g., a cellular or satellite network) and the second device 950. The second device 950 delivers and receives audio signals associated with the phone call to and from the user.

Simultaneously with using the second device 950 as a mobile phone handset, the user is holding the first device 990 in his or her other hand, and can easily view a first display 910 of the first device 990. Thus, the user can utilize the full capabilities of the mobile device without having to remove the second device 950 from his or her ear. For example, a user can use the first device 990 to look up another person's phone number, check and update their calendar, or access the Internet to read restaurant reviews, search for directions, etc., all while continuing to conduct a private phone conversation. The mobile device can receive the physical location of the calling party or another party to the call. If the mobile device is GPS-enabled, it can also determine its own location, allowing a user to bring up a map showing the location of both the user and another party to the call, and plot a route between the locations on the map. The mobile device 900 can be configured to update the location of the user and another party in real-time both during and after the phone call, and to indicate places of interest along the route. These non-phone capabilities can be utilized without a user having to pause the conversation (in order to perform these tasks using the second device handset 950), or to disrupt the privacy of the call by using the phone's speakerphone mode.

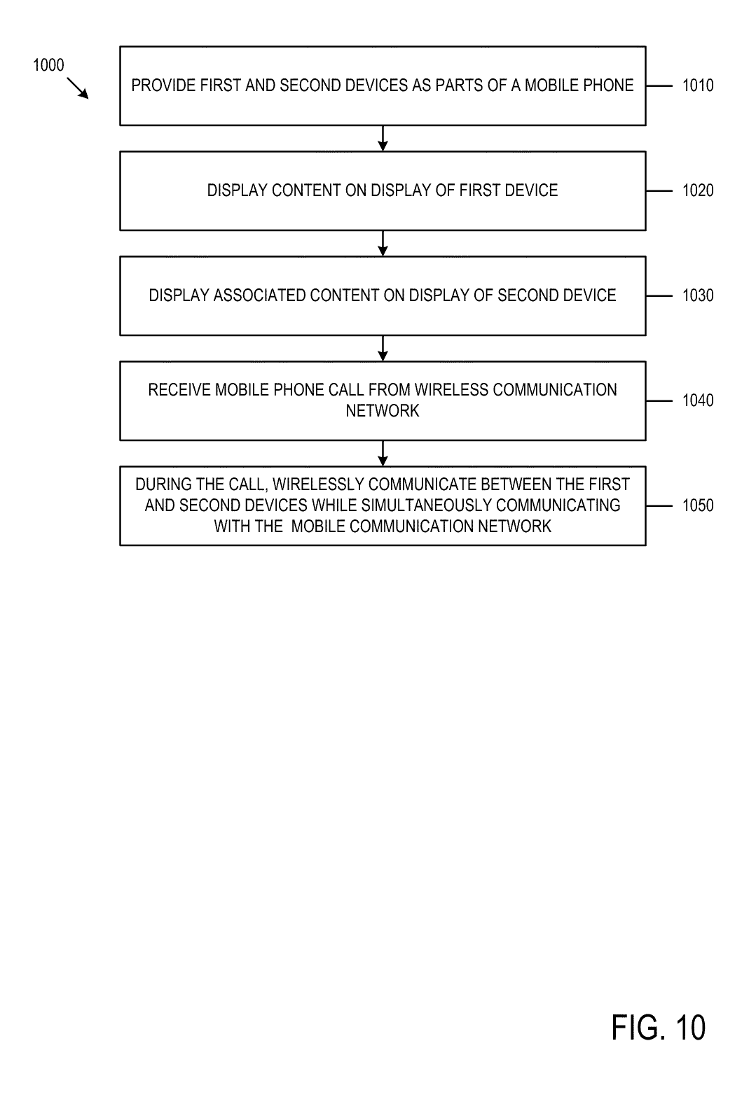

FIG. 10 is a flowchart of a first embodiment 1000 of a method of operating a dual display mobile device as a phone. The method 1000 can be executed by, for example, a mobile device simultaneously hosting a mobile phone call an application, such as running navigation software. At 1010, first and second devices are provided as parts of a mobile phone. Each device has a display and the two devices can be detached from each other. At 1020, content, such as a navigational route, is displayed on the display of the first device. At 1030, associated content, such as directions for the navigational route, is displayed on the display of the second device. At 1040, a mobile phone call is received from a wireless communication network. At 1050, during the call, the first and second devices wirelessly communicate with each other simultaneous with the mobile device communicating with the mobile communication network. For example, the first device can communicate via cellular modem with the wireless communication network and act as a base station to transmit voice data wirelessly to the second device.

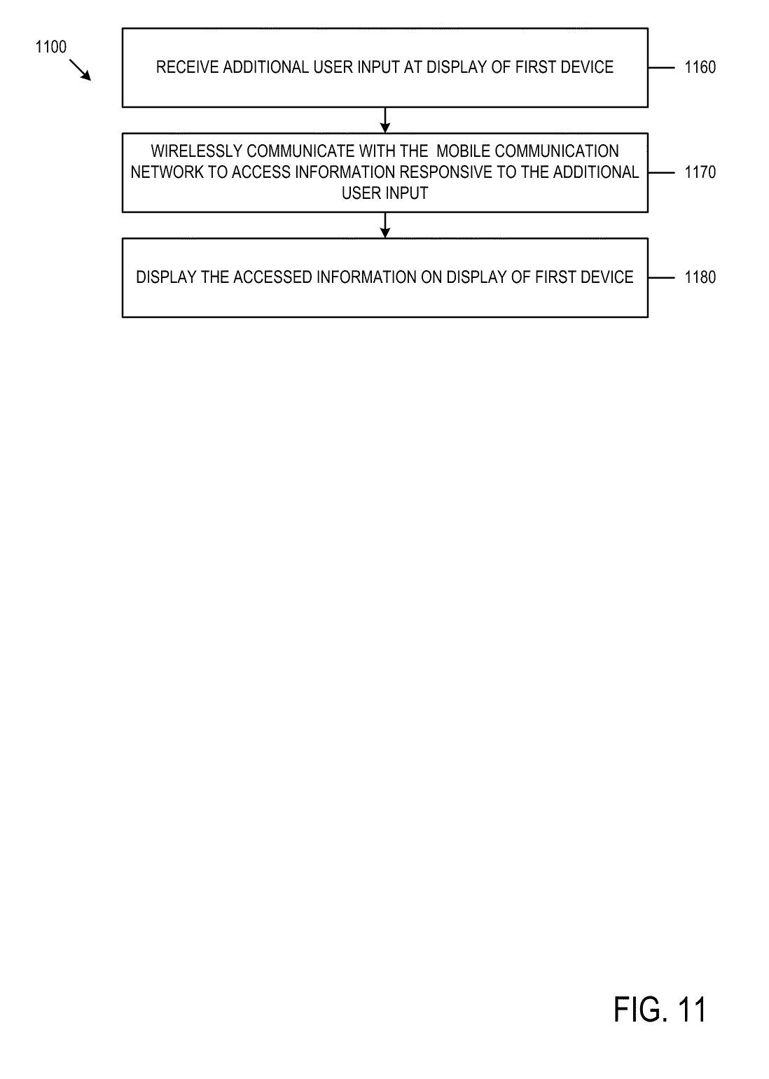

FIG. 11 is a flowchart of additional operations that can be performed as part of the flowchart shown in FIG. 10. The additional operations are for wirelessly communicating with a mobile communication network to retrieve information in response to user input received during the mobile phone call. For instance, in the above example, the mobile device simultaneously hosting the call and running navigation software can access the Internet during the call to find the location movie theater in response to a user request. At 1160, additional user input, such as a search request for nearby movie theaters, is received at the display of the first device. At 1170, the mobile phone wirelessly communicates with the mobile communication network to access information responsive to the additional input. For example, the mobile phone can access the Internet to retrieve a list of nearby theaters. At 1180, the accessed information, such as the list of theaters or directions to a specific theater, is displayed on the first device display.

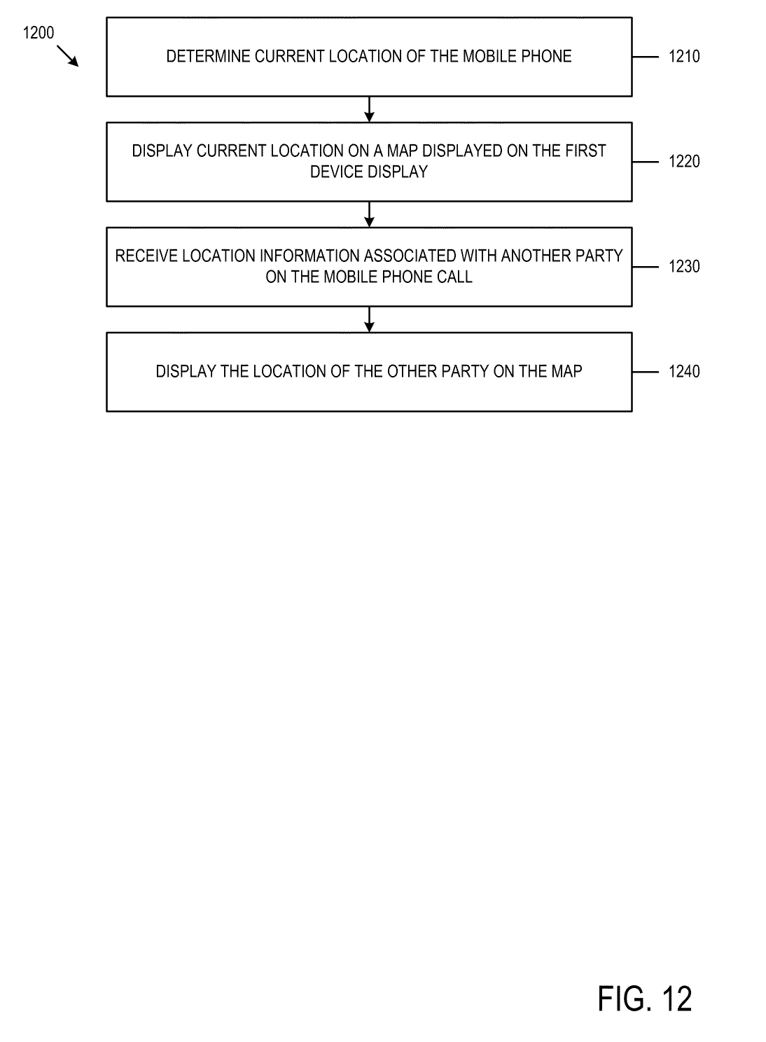

FIG. 12 is a flowchart of other additional operations that can be performed as part of the method shown in FIG. 10. The alternative operations are for displaying the location of the mobile phone and another party to the call on a map displayed on the device. For instance, in the above example, the mobile device simultaneously hosting the call and running navigation software can display both its location and the location of another party to the call on a map. At 1210, the current location of the mobile phone is determined. At 1220, the current location of the phone is displayed on the map shown on the first device display. At 1230, location information associated with another party to the phone call is received. At 1240, the location of the other party is displayed on the map. The method 1200 further comprises displaying a route between the parties. Points of interest (restaurants, movie theaters, museums, stores, etc.) along the route can also be shown as well.

In any of the examples disclosed herein, the mobile device can operate as a mobile phone in any mobile device configuration (open or closed, attached or detached). For example, when a mobile device is in a closed configuration, notice of an incoming call can be provided at the first display and the first device can operate as the phone handset. During a call, a user can transform the mobile device from a closed to an open configuration, detach the second device from the first device and continue the call using the second device as the phone handset. In such a case, the mobile device can be configured to detect when the second device is detached from the first device and automatically switch to using the second device as the phone handset. The mobile device can also be configured to automatically switch to using the first device as the phone handset when the mobile device detects that the second device has been reattached to the first device. A controller of the first device (e.g., controller 810) can be configured to monitor whether a second device is connected to or detached from the first device, and to automatically switch between wireless and physical communication modes for communicating with the second device. Alternatively, the user can select whether the first device or the second device is to be used as a phone handset. For example, the first device can continue operating as a phone handset when the second device is detached from the first device.

Notice of an incoming call, text message, email or any other type of communication can be displayed on either the first display, the second display, or both displays. For example, notification of an incoming call can be displayed on a second display and can comprise the calling party's name, phone number and an associated image. If either the first or the second device is communicating with an external device such as a television, personal computer or other media player, notification can be provided to the external device as well. Notification can be made by an audio and/or video signal.

In any of the mobile devices as described herein, the first and second devices can simultaneously operate as a handset during a call, thus allowing two users at one end of the phone call to participate in the call. The second device can operate as a phone handset when the first device is docked at a communication location, charging station, etc., attached to an external device by a cable, or is otherwise prevented from being moved. For example, when the first device is outputting media to an external media player via a wireless connection, the first device must remain within physical proximity to the media player.

A detached second device can cooperate with a first device in additional configurations. For example, a mobile device can be used as a car navigation system. A first device can be running a map or navigation application, and the second device can display step-by-step directions for a route displayed on the first display. Alternatively, the second device operates independently of the first device. For example, the second device can operate as a media player and output audio data to a car's sound system via either a wired or a wireless connection. The first device could be placed in a dashboard mount, and the second device could be placed in the same mount as the first device, a separate mount, or elsewhere within the driver's view. Notification of an incoming call can be displayed on the first display, the second display or both displays. Either device can be configured to perform operations in response to voice commands, allowing for hands free operation while a user is driving or performing other tasks. For example, the mobile device can be configured to answer or place a call, play a song or launch an application in response to a voice command.

In any of the examples described herein, the mobile device can be configured to operate in a “three screen” mode in which the mobile device can output media or content to a television, monitor or other external device comprising a viewable display. The media can be output to the external device by the first device, either wirelessly or through a physical connection. For example, the first device could be docked and the media can be output via a cable connecting the docking station to the external device. In some embodiments, the second device can output the media to the external device. In other embodiments, both the first and second devices can output the media to the external device. Regardless of which device outputs content, the first and/or second devices can control the output of media to the external media player.

In one example of a mobile device operating in “three screen” mode, a detached second device can remotely control the output of signals sent by a first device to an external media player. For instance, the second device can control browsing of a media gallery (photo, video, audio, etc.) displayed on the external media device. A user can control browsing of the gallery by providing touch input (tap input, flick or multi-touch gestures, etc.) or by gesturing with the second device. For example, left-right or right-left gestures can cause a previous or following media file to be displayed, and a down-up gesture can cause media file to be played. The second device can also be configured to display information complementary to that displayed on the external display by the primary device. For example, the second device can show thumbnails of photographs displayed on the external media device.

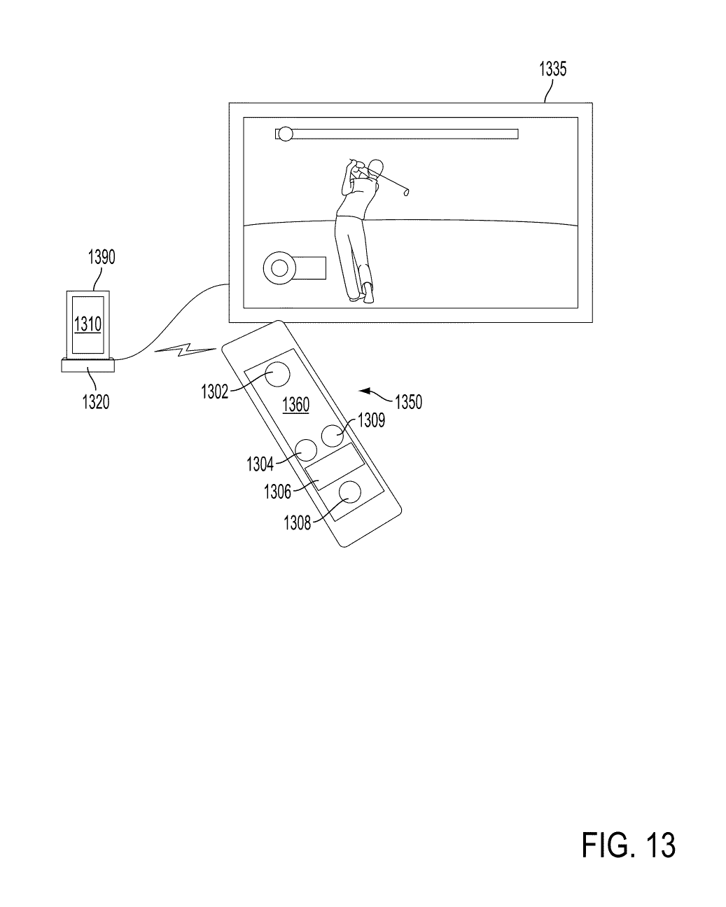

In another example, a detached second device can act as a remote game controller. FIG. 13 shows a first device 1390 docked with a docking station 1320 and delivering output to a television 1335. Although a wired connection is shown, communication between the dock 1320 and the television 1335 can be wireless. The corresponding second device 1350 can display game controls 1302, 1304, 1306, 1308, and 1309 on a second display 1360 and provide input to the game running on the first device 1390 via wireless communication. In yet another example, a detached second device communicating wirelessly with a first device can act as a virtual keyboard to provide text input to an application running on the first device and whose output is displayed on a computer, television or other device.

The second device can provide remote input to an application running on the first device whose output is displayed on the first display. For example, the golf application displayed on the television 1335 can be displayed on a first display 1310 of the first device 1390. A user can motion or gesture with the second device 1350 to simulate a golf swing and an accelerometer in the second device can detect the motion. The second device can wirelessly communicate data indicating the detected motion to the first device, and a corresponding golfing action can be displayed on the first display 1310.

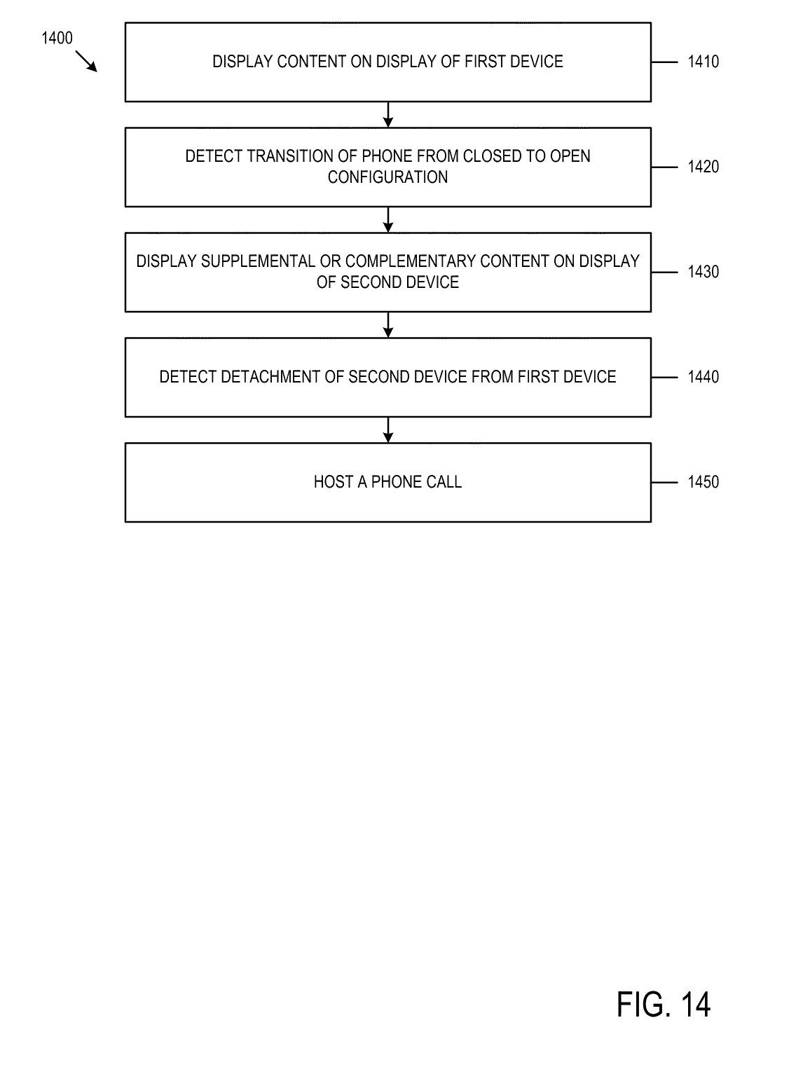

FIG. 14 is a flowchart of a second embodiment 1400 of a method of operating a dual display mobile device as a mobile phone. The method 1400 can be executed, for example, by a mobile device being opened to expose both displays, having its second device detached, and hosting a mobile phone call. At 1410, content is displayed at a first device display. The content can be the output of an application running on the mobile phone, such as an email program. At 1420, transition of the phone from a closed configuration to an open configuration is detected. In the example, the mobile phone can detect the user expanding the mobile phone to show the second display. At 1430, supplemental or complementary content, such as an email message preview pane or a virtual keyboard, is displayed on the second device display. At 1440, detachment of the second device from the first device is detected. In the example, the mobile device can detect a user detaching the second device to make a phone call or receive an incoming call. At 1450, the mobile phone can host a phone call. As part of hosting the call, the first and second devices can wirelessly communicate with each other while the mobile phone simultaneously wirelessly communicates with a mobile communication network.

In any of the examples described herein, the first and second devices can be configured to operate independently when they are out of communication range with each other. In such a configuration, first or second devices containing a wireless modem capable of communicating with a mobile communications network can operate as a mobile phone. Typically, this will be the first device. Any first or second device not capable of communicating with a cellular or satellite mobile communication network can still perform a wide range of functions. For example, a second device can operate as a stand-alone media player. A user can take such a second device with him or her to the gym, on a walk, etc. and listen to songs stored on second device. Any of the mobile devices as described herein comprising a detachable second device can thus provide a user with the option of carrying a smaller mobile device when not all of the capabilities of the first device are needed, or when a more compact mobile device is desired. As discussed above, the second device can communicate with other nearby devices configured for wireless communication. For example, equipment at a gym (treadmill, exercise bike, etc.) can be enabled for wireless communication and the second device can transmit audio and/or video media for output by the gym equipment.

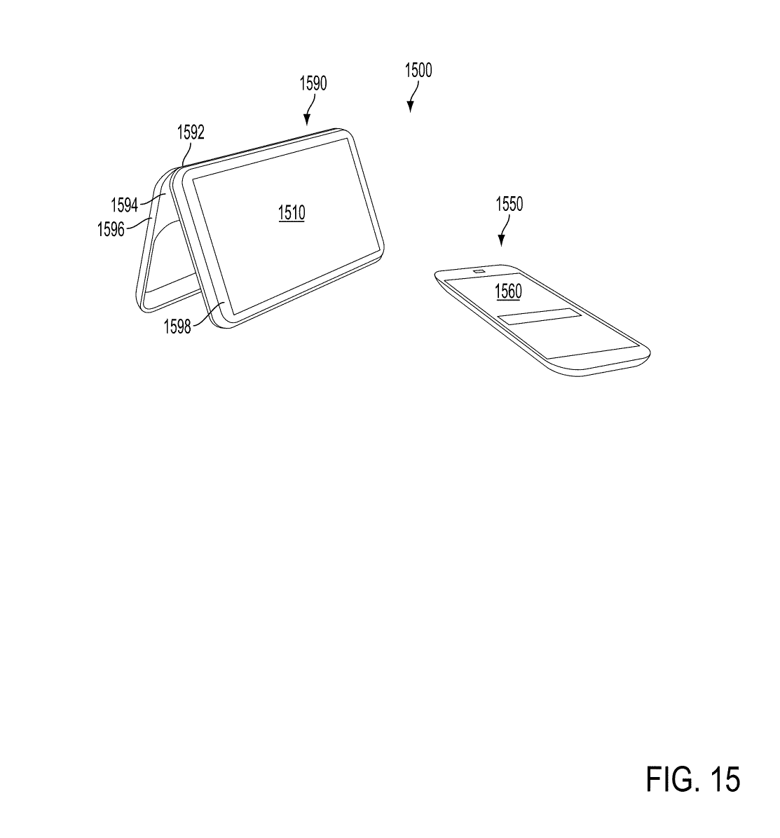

In any of the exemplary mobile devices described herein, a detachable secondary device can be stowed or attached to a first device in a manner other than that shown in FIGS. 1 through 5. For example, FIG. 15 shows a mobile device 1500 comprising a first device 1590 and a second device 1550. The first device comprises a first display 1510 and a hinged edge 1592. The second device 1550 comprises a second display 1560. The first device 1590 can be opened by pivoting a back face 1596 away from a front face 1598 to reveal a cavity 1594 in which the second device 1550 can be stored. The hinged edge 1592 also allows the first device 1590 to stand upright when the first device is opened to reveal the cavity 1594.

Additional embodiments and aspects of the technologies described herein are described in the following numbered embodiments.

### Embodiment 1

A mobile phone (200, 500), comprising: a first device (290, 590) having a first display (210, 510) and a first wireless modem (835); a second device (250, 550) having a second display (260, 560) and a second wireless modem (885), the second device (250, 550) operable as a handset of the mobile phone (200, 500); the first and second devices (290, 590, 250, 550) being slidably attachable to each other and releasable from each other so that in a closed configuration, the first and second devices (290, 590, 250, 550) are attached and the second display (260, 560) is hidden beneath the first device (290, 590); in an open configuration, the first and second devices (290, 590, 250, 550) are attached and the first and second displays (210, 510, 260, 560) are both visible and function as a single integrated display; and in a detached configuration, the first and second devices (290, 590, 250, 550) are detached from one another for wireless communication there between.

### Embodiment 2

The mobile phone (200, 500) of any of the previous numbered embodiments, wherein the second device (250, 550) can slide both horizontally and vertically with respect to the first device (290, 590) to allow the first and second displays (210, 510, 260, 560) be substantially flush with each other in the open configuration.

### Embodiment 3

The mobile phone (200, 500) of any of the previous numbered embodiments, wherein the first device (290, 590) further comprises a cellular modem (807) that is separate from the first wireless modem (835).

### Embodiment 4

The mobile phone (200, 500) of any of the previous numbered embodiments, further comprising a connector (836) for electrically connecting the first and second devices (290, 590, 250, 550), the first and second devices (290, 590, 250, 550) operable to communicate electrically when physically connected using the connector (836) and wirelessly when detached.

### Embodiment 5

The mobile phone (200, 500) of any of the previous numbered embodiments, wherein the first device (290, 590) comprises a controller (810) configured to monitor whether the second device (250, 550) is connected to or detached from the first device (290, 590) and for automatically switching modes of communication with the second device (250, 550) based on the monitoring.

### Embodiment 6

The mobile phone (200, 500) of any of the previous numbered embodiments, wherein the second device (250, 550) further comprises a cellular modem that is separate from the second wireless modem (885).

### Embodiment 7

A method of using a mobile phone (200, 500), comprising: providing first and second devices (290, 590, 250, 550) as parts of the mobile phone (200, 500) that are releasably attachable from each other; displaying first content on a first display (210, 510) of the first device (290, 590); displaying second content associated with the first content on a second display (260, 560) of the second device (250, 550); receiving a mobile phone call from a wireless communication network (809); and during the mobile phone call, wirelessly communicating between the first and second devices (290, 590, 250, 550) while simultaneously communicating with the wireless communication network (809).

### Embodiment 8

The method of any of the previous numbered embodiments, further comprising detecting detachment of the second device (250, 550) from the first device (290, 590) and switching a mode of communication between the first and second devices (290, 590, 250, 550) to wireless.

### Embodiment 9

The method of any of the previous numbered embodiments, further comprising operating the first and second devices (290, 590, 250, 550) to act as separate handsets during the mobile phone call.

### Embodiment 10

The method of any of the previous numbered embodiments, wherein the displaying the first and second content comprises operating the first and second displays (210, 510, 260, 560) as an integrated display;

### Embodiment 11

The method of any of the previous numbered embodiments, further comprising: during the mobile phone call: receiving additional user input at the first display (210, 510); wirelessly communicating with the mobile communication network (809) to access information responsive to the additional user input; and displaying the accessed information on the first display (210, 510).

### Embodiment 12

The method of any of the previous numbered embodiments, further comprising: determining a current location of the mobile phone (200, 500); displaying the current location of the mobile phone (200, 500) on a map displayed on the first display (210, 510) during the mobile phone call; receiving location information associated with another party on the mobile phone call; and displaying the location of the other party on the map.

### Embodiment 13

The method of any of the previous numbered embodiments, further comprising updating the second display (260, 560) in response to user input received at the first display (210, 510).

### Embodiment 14

A method of using a mobile phone (200, 500), comprising: displaying first content on a first display (210, 510) of a first device (290, 590) of the mobile phone (200, 500) with the mobile phone (200, 500) in a closed position; detecting a transition of the mobile phone (200, 500) from a closed position to an open position wherein a second display (260, 560) of a second device (250, 550) of the mobile phone (200, 500) is exposed in the open position; in response to the detection, displaying second content on the second display (260, 560) that is supplemental or complementary to the first content; detecting detachment of the second device (250, 550) from the first device (290, 590); and hosting a phone call, wherein the first device (290, 590) communicates wirelessly with a mobile communication network (809) and simultaneously communicates wirelessly with the second device (250, 550) such that the second device (250, 550) operates as a handset of the mobile phone (200, 500).

### Embodiment 15

A method of using a mobile device (200, 500), comprising: outputting content from a first device (290, 590, 1390) of the mobile device (200, 500) to an external device (1335), the content output from the first device (290, 590, 1390) for display on the external device (1335); detecting user input at a second device (250, 550, 1350) of the mobile device (200, 500) for controlling the output of content; wirelessly communicating signals associated with the user input from the second device (250, 550, 1350) to the first device (290, 590, 1390); controlling the output of content from the first device (290, 590, 1390) based on the signals.

In view of the many possible embodiments to which the principles of the disclosed invention may be applied, it should be recognized that the illustrated embodiments are only preferred examples and should not be taken as limiting the scope of the invention. Rather, the scope of the invention is defined by the following claims. We therefore claim as our invention all that comes within the scope of these claims.

We claim:

1. A mobile phone, comprising:
a first device having a first display and a first wireless modem;
a second device having a second display and a second wireless modem, the second device operable as a handset of the mobile phone;
the first and second devices being slidably attachable to each other and releasable from each other so that in a closed configuration, the first and second devices are attached and the second display is hidden beneath the first device; in an open configuration, the first and second devices are attached and the first and second displays are both visible and function as a single integrated display; and in a detached configuration, the first and second devices are detached from one another for wireless communication there between.

2. The mobile phone of claim 1, wherein the second device can slide both horizontally and vertically with respect to the first device to allow the first and second displays be substantially flush with each other in the open configuration.

3. The mobile phone of claim 1, wherein the first device further comprises a cellular modem that is separate from the first wireless modem.

4. The mobile phone of claim 1, wherein the second device further comprises an accelerometer for detecting motion of the second device.

5. The mobile phone of claim 1, further comprising a connector for electrically connecting the first and second devices, the first and second devices operable to communicate electrically when physically connected using the connector and wirelessly when detached.

6. The mobile phone of claim 5, wherein the connector allows the first and second devices to be recharged using a single power source.

7. The mobile phone of claim 1, wherein the first device comprises a controller configured to monitor whether the second device is connected to or detached from the first device and for automatically switching modes of communication with the second device based on the monitoring.

8. The mobile phone of claim 1, wherein the second device further comprises a cellular modem that is separate from the second wireless modem.

9. The mobile phone of claim 1, wherein the first device is operable as a handset of the mobile phone.

10. The mobile phone of claim 1, wherein in the open and closed configurations, a front surface and a back surface of the mobile phone are substantially planar.

11. The mobile phone of claim 1, wherein the first and second displays are touch screens for receiving user input.

12. A method of using a mobile phone, comprising:
providing first and second devices as parts of the mobile phone that are releasably attachable from each other;
displaying first content on a first display of the first device;
displaying second content associated with the first content on a second display of the second device;
receiving a mobile phone call from a wireless communication network; and during the mobile phone call, wirelessly communicating between the first and second devices while simultaneously communicating with the wireless communication network.

13. The method of claim 12, further comprising detecting detachment of the second device from the first device and switching a mode of communication between the first and second devices to wireless.

14. The method of claim 12, further comprising operating the first and second devices to act as separate handsets during the mobile phone call.

15. The method of claim 12, wherein the displaying the first and second content comprises operating the first and second displays as an integrated display.

16. The method of claim 12, further comprising:
during the mobile phone call:
receiving additional user input at the first display;
wirelessly communicating with the mobile communication network to access information responsive to the additional user input; and
displaying the accessed information on the first display.

17. The method of claim 12, further comprising:
determining a current location of the mobile phone;
displaying the current location of the mobile phone on a map displayed on the first display during the mobile phone call;
receiving location information associated with another party on the mobile phone call; and
displaying the location of the other party on the map.

18. The method of claim 12, further comprising sliding the second device vertically and horizontally with respect to the first device so that in a closed position the second device is arranged behind the first device and in an open position the second display is flush with the first display.

19. The method of claim 12, further comprising updating the second display in response to user input received at the first display.

20. A method of using a mobile phone, comprising:
displaying first content on a first display of a first device of the mobile phone with the mobile phone in a closed position;
detecting a transition of the mobile phone from a closed position to an open position wherein a second display of a second device of the mobile phone is exposed in the open position;
in response to the detection, displaying second content on the second display that is supplemental or complementary to the first content;
detecting detachment of the second device from the first device; and
hosting a phone call, wherein the first device communicates wirelessly with a mobile communication network and simultaneously communicates wirelessly with the second device such that the second device operates as a handset of the mobile phone.
